(19) United States
(12) Patent Application Publication
(10) Pub. No.: US 2007/0042113 A1
(43) Pub. Date: Feb. 22, 2007

(54) METHODS AND APPARATUS FOR INKJET PRINTING COLOR FILTERS FOR DISPLAYS USING PATTERN DATA

(75) Inventors: Hongbin Ji, Santa Clara, CA (US); Inchen Huang, Fremont, CA (US); Bassam Shamoun, Fremont, CA (US); Quanyuan Shang, Saratoga, CA (US); Shinichi Kurita, San Jose, CA (US); John M. White, Hayward, CA (US)

Correspondence Address: DUGAN & DUGAN, PC, 55 SOUTH BROADWAY, TARRYTOWN, NY, 10591, US

(73) Assignee: Applied Materials, Inc., Santa Clara, CA (US)

(21) Appl. No.: 11/466,507

(22) Filed: Aug. 23, 2006

Related U.S. Application Data
(63) Continuation-in-part of application No. 11/238,632, filed on Sep. 29, 2005.
Application No. 11/238,632 is a continuation-in-part of application No. 11/061,148, filed on Feb. 18, 2005.
(60) Provisional application No. 60/625,550, filed on Nov. 4, 2004.

(51) Int. Cl. B05D 5/06

(52) U.S. Cl. 427/162

(57) ABSTRACT

The invention provides methods, systems, and drivers for controlling an inkjet printing system and manufacturing display objects. The system may include a print controller including one or more drivers, at least one print head coupled to the drivers, a stage controller coupled to the print controller, one or more motors coupled to the stage controller, encoders coupled to the motors and the stage controller, and a host coupled to the stage controller and the print controller. The host is adapted to transfer pattern parameter data to the print controller, and the print controller is adapted to use the pattern parameter data to trigger the at least one print head to deposit ink into pixel wells on a substrate as the substrate is moved in a print direction by the at least one motor under the direction of the stage controller in response to a command from the host.

The present invention is a continuation-in-part of U.S. patent application Ser. No. 11/238,632, Attorney Docket No. 9521/P02, filed on Sep. 29, 2005 and entitled “METHODS AND APPARATUS FOR INKJECT PRINTING OF COLOR FILTERS FOR DISPLAYS,” which is a continuation-in-part of U.S. patent application Ser. No. 11/061,148 filed Feb. 18, 2005 and entitled “METHODS AND APPARATUS FOR INKJET PRINTING OF COLOR FILTERS FOR DISPLAYS,” which claims the benefit of U.S. Provisional Patent Application Ser. No. 60/625,550 filed Nov. 4, 2004 and entitled “APPARATUS AND METHODS FOR FORMING COLOR FILTERS IN A FLAT PANEL DISPLAY BY USING INKJETTING,” each of which is hereby incorporated by reference herein in its entirety.

### CROSS REFERENCE TO RELATED APPLICATIONS

The present application is related to U.S. patent application Ser. No. 11/061,120, Attorney Docket No. 9769, filed on Feb. 18, 2005 and entitled “METHODS AND APPARATUS FOR PRECISION CONTROL OF PRINT HEAD ASSEMBLIES” which is hereby incorporated by reference herein in its entirety.

The present application is also related to U.S. patent application Ser. No. 11/238,637, Attorney Docket No. 10003, filed on Sep. 29, 2005 and entitled “METHODS AND APPARATUS FOR A HIGH RESOLUTION INKJET FIRE PULSE GENERATOR” which is hereby incorporated by reference herein in its entirety.

### FIELD OF THE INVENTION

The present invention relates generally to systems for manufacturing color filters for flat panel displays, and is more particularly concerned with systems and methods for controlling operation of an inkjet printer used to print color filters.

### BACKGROUND OF THE INVENTION

The flat panel display industry has been attempting to employ inkjet printing to manufacture display devices, in particular, color filters. One problem with effective employment of inkjet printing is that it is difficult to inkjet ink or other material accurately and precisely on a substrate while having high throughput. It is also cumbersome and inefficient to guide inkjets using highly detailed information that requires significant memory resources and download time. Accordingly, methods and apparatus are needed to efficiently and precisely drive a printer control system.

### SUMMARY OF THE INVENTION

In certain aspects, the present invention provides a system for manufacturing display objects. The system may include a print controller including one or more drivers, at least one print head coupled to the drivers, a stage controller coupled to the print controller, one or more motors coupled to the stage controller, encoders coupled to the motors and the stage controller, and a host coupled to the stage controller and the print controller. The host is adapted to transfer pattern parameter data to the print controller, and the print controller is adapted to use the pattern parameter data to trigger the at least one print head to deposit ink into pixel wells on a substrate as the substrate is moved in a print direction by the at least one motor under the direction of the stage controller in response to a command from the host.

In other aspects, the present invention provides an apparatus for controlling an inkjet printing system. The apparatus may include logic including a processor, memory coupled to the logic, and a fire pulse generator circuit coupled to the logic and including a connector to facilitate coupling to a print head. The logic is adapted to receive pattern parameter data, and the logic is further adapted to trigger the print head to deposit ink into pixel wells on a substrate as the substrate is moved in a print direction based on the pattern parameter data.

In further aspects, the present invention provides a method of manufacturing an inkjet printing system. The method includes providing logic including a processor, coupling memory to the logic, coupling a fire pulse generator circuit to the logic, coupling a connector to the fire pulse generator to facilitate coupling to a print head, and adapting the logic to receive pattern parameter data to be used to trigger the print head to deposit ink into pixel wells on a substrate as the substrate is moved in a print direction.

In still further aspects, the present invention provides a method of printing color filters. The method includes receiving pattern parameter data, controlling a fixed current source fire pulse generator circuit based on the pattern parameter data, and activating a print head using a fire pulse generated by the fixed current source fire pulse generator circuit.

Other features and aspects of the present invention will become more fully apparent from the following detailed description, the appended claims and the accompanying drawings.

### BRIEF DESCRIPTION OF THE DRAWINGS

FIG. 1A is a schematic illustration of an inkjet print system according to some embodiments of the present invention.

FIG. 1B is a schematic illustration depicting details of a print controller as shown in FIG. 1A according to some embodiments of the present invention.

FIG. 1C is a schematic illustration depicting details of a driver as shown in FIG. 1B according to some embodiments of the present invention.

FIG. 1D is a partial schematic illustration depicting details of a fire pulse generator circuit as shown in FIG. 1C according to some embodiments of the present invention.

FIG. 1E is a graph depicting the voltage signal generated by the fire pulse generator circuit as shown in FIG. 1D according to some embodiments of the present invention.

FIG. 1F is a schematic illustration of representative logic of a driver as depicted in FIG. 1C according to some embodiments of the present invention.

FIG. 1G is a perspective view of an inkjet print system according to some embodiments of the present invention.

FIG. 2A is a flowchart illustrating an example of a method of system operation according to some embodiments of the present invention.

FIG. 2B is a logic timing diagram that illustrates an example embodiment of the relationships between different signals of an inkjet print system according to the present invention.

FIG. 3 is a top view of a substrate including display objects for use with an inkjet print system according to some embodiments of the present invention.

FIG. 4 is a magnified view of a single display pixel of a display object on a substrate for use with an inkjet print system according to some embodiments of the present invention.

FIG. 5 is a flowchart illustrating an example of a method according to some embodiments of the present invention.

FIG. 6 is a top view of a substrate illustrating pattern parameters according to some embodiments of the present invention.

### DETAILED DESCRIPTION

In an inkjet printer, an inkjet printer control system activates individual nozzles within one or more inkjet print heads to deposit or eject ink (or other fluid) droplets onto a substrate. As the substrate moves relative to the print heads, activation of the nozzles is synchronized with the motion of the substrate so that ink is deposited at precisely defined locations on the substrate. Substrates have different sizes and display patterns and offsets, and nozzles have varied parameters and alignment, so that precise deposition is not necessarily a trivial operation; however, in practice, there is often sufficient regularity in the deposition patterns that the information used to direct and activate the nozzles can be substantially simplified as compared to an exhaustive list of every drop location.

The present invention provides apparatus and methods for generating information enabling a filter to be “printed” on a substrate based on pattern parameter data and certain device parameters. Thus, a print system according to the present invention may accurately and rapidly deposit fluid on a substrate to form one or more filters. The inkjet control system of the present invention also allows flexibility with regard to the size of the substrate, which can be set in real time for each printing.

An exemplary algorithm for printing based on a limited set of parameters such as drop spacing, drop size, number of pixels per display, and other numerical parameters is described below. The exemplary algorithm allows pattern information to be simplified so that the information can rapidly be converted into actual inkjet printing commands.

More specifically, a pixel pattern such as a line of drops can be efficiently represented by pattern data including drop spacing, drop size, inter-pixel spacing, number of pixels per display, number of displays per substrate, and inter-display spacing. A fire pulse voltage magnitude and width can be retrieved for each drop based on this information, and then sent to the appropriate nozzle to trigger the dispensing of fluid. By simplifying pixel pattern information in this way, large amounts of data that would otherwise need to be communicated and saved locally within the printer controller can be avoided, allowing for more streamlined and less expensive controller designs. In some embodiments, a color filter for a display may include a matrix of predefined pixel wells formed on a substrate that will be display pixels when the wells are filled with ink. The matrix may be formed using lithography or other processes. For example, the pixel wells may be laid out on the substrate before printing using a process of coating, masking and etching.

System Overview

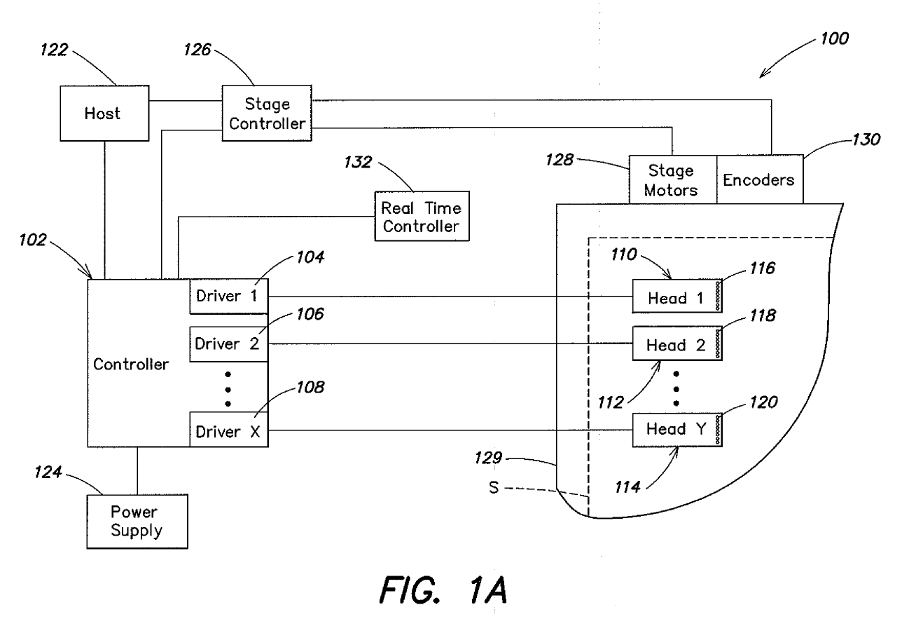

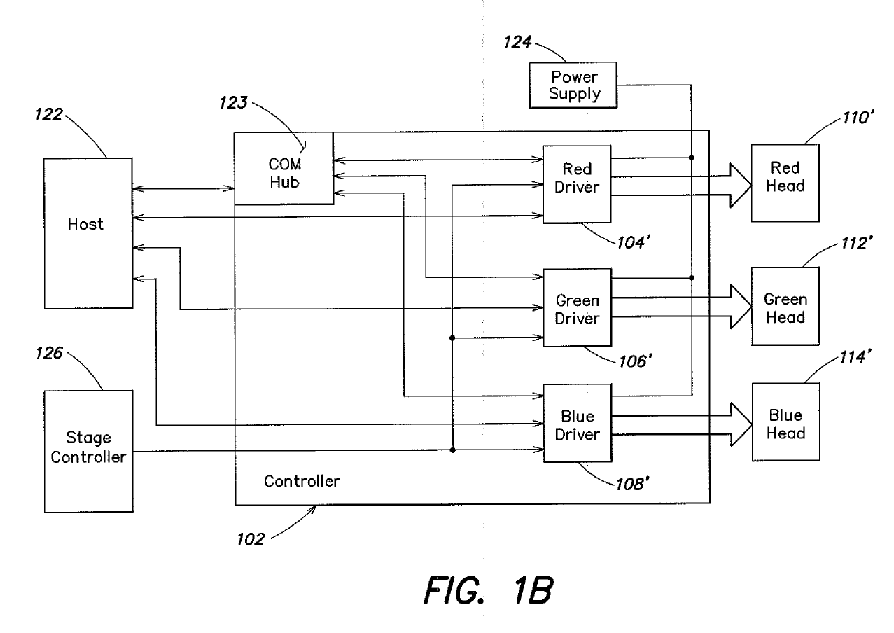

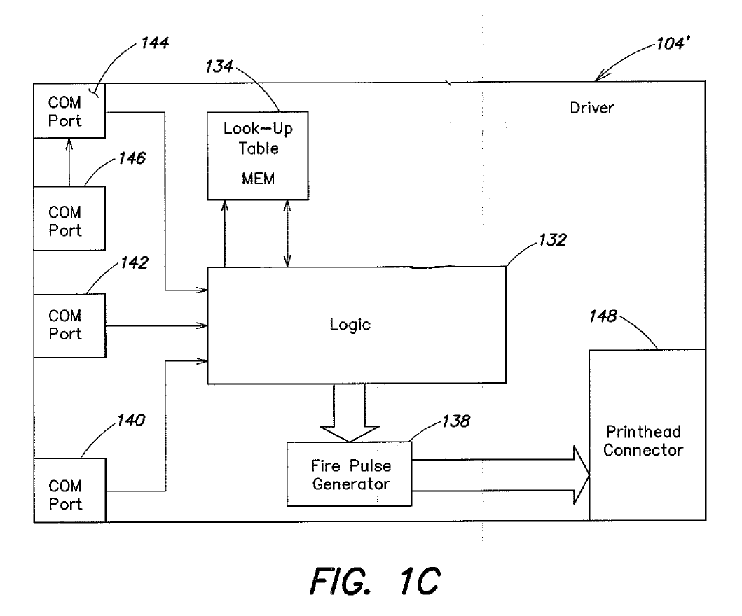

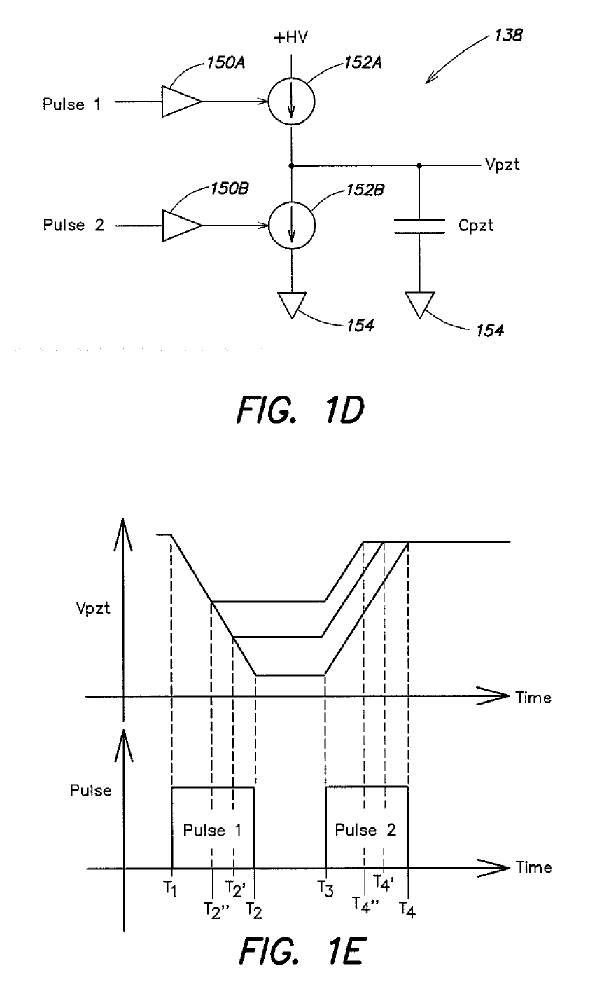

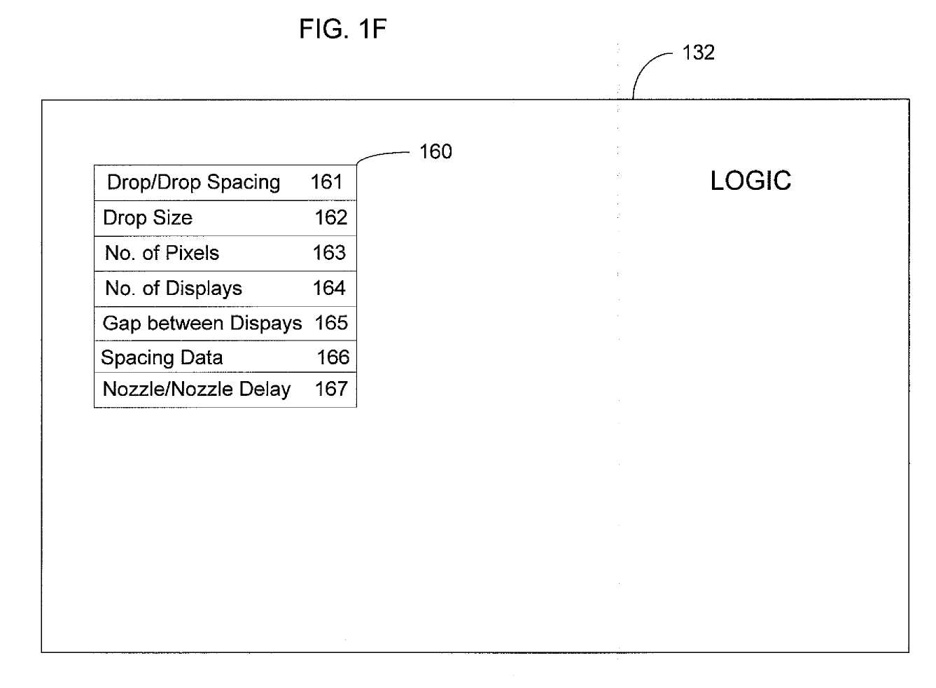

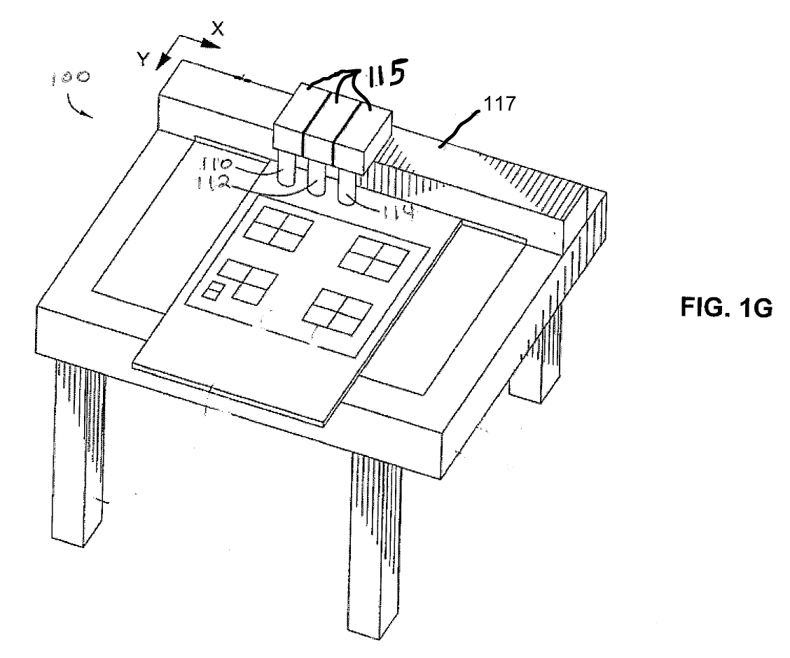

Turning to FIG. 1A, a schematic illustration of an example embodiment of an inkjet print system 100 is provided. An inkjet print system 100 may include a controller 102 that includes logic, communication, and memory devices. The controller 102 may alternatively or additionally include one or more drivers 104, 106, 108 that may each include logic to transmit control signals (e.g., fire pulse signals) to one or more print heads 110, 112, 114. The print heads 110, 112, 114, may include one or more nozzles 116, 118, 120 for depositing fluid such as ink drops on a substrate S (shown in phantom). The controller 102 may additionally be coupled to a host computer 122 for receiving graphics data and other data and to a power supply 124 for generating amplified firing pulses.

In the embodiment shown in FIG. 1A, the host computer 122 is coupled to a stage controller 126 that may provide XY (e.g., horizontal and vertical) move commands to position the substrate S relative to the print heads 110, 112, 114. For example, the stage controller 126 may control one or more motors 128 to move a stage 129 that supports the substrate S. One or more encoders 130 may be coupled to the motors 128 and/or the stage 129 to provide motion feedback to the stage controller 126 which in turn may be coupled to the controller 102 to provide a signal that may be used to track the position of substrate S relative to the print heads 110, 112, 114. In some embodiments, a real time controller 132 may also be coupled to the controller 102 to provide a jet enable signal for enabling deposition of ink (or other fluid). Although a connection is not pictured, the real time controller 132 may receive signals from the stage controller 126 and/or the encoders 130 in order to determine when the jet enable signal is to be asserted in some embodiments.

The controller 102 may be implemented using one or more field programmable gate arrays (FPGA) or other similar devices. In some embodiments, discrete components may be used to implement the controller 102. The controller 102 may be adapted to control and/or monitor the operation of the inkjet print system 100 and one or more of various electrical and mechanical components and systems of the inkjet print system 100 which are described herein. In some embodiments, the controller 102 may be any suitable computer or computer system, or may include any number of computers or computer systems.

In some embodiments, the controller 102 may be or may include any components or devices which are typically used by, or used in connection with, a computer or computer system. Although not explicitly pictured in FIG. 1, the controller 102 may include a central processing unit(s), a read only memory (ROM) device and/or a random access memory (RAM) device. The controller 102 may also include an input device such as a keyboard and/or a mouse or other pointing device, an output device such as a printer or other device via which data and/or information may be obtained, and/or a display device such as a monitor for displaying information to a user or operator. The controller 102 may also include a transmitter and/or a receiver such as a LAN adapter or communications port for facilitating communication with other system components and/or in a network environment, one or more databases for storing any appropriate data and/or information, one or more programs or sets of instructions for executing methods of the present invention, and/or any other computer components or systems, including any peripheral devices.

According to some embodiments of the present invention, instructions of a program may be read into a memory of the controller 102 from another medium, such as from a ROM device to a RAM device or from a LAN adapter to a RAM device. Execution of sequences of the instructions in the program may cause the controller 102 to perform one or more of the process steps described herein. In alternative embodiments, hard-wired circuitry or integrated circuits may be used in place of, or in combination with, software instructions for implementation of the processes of the present invention. Thus, embodiments of the present invention are not limited to any specific combination of hardware, firmware, and/or software.

As indicated above, the controller 102 may generate, receive, and/or store databases including data related to patterns of pixels to be printed, substrate layout data, print head calibration/drop displacement data, and/or substrate positioning and offset data. As will be understood by those skilled in the art, the schematic illustrations and accompanying descriptions of the sample data structures and relationships presented herein are exemplary arrangements for stored representations of information. Any number of other arrangements may be employed besides those suggested by the illustrations provided.

The drivers 104, 106, 108 may be embodied as a portion or portions of the controller's 102 logic as represented in FIG. 1A. In alternative and/or additional embodiments, the drivers 104, 106, 108 may embody the entire controller 102 or the drivers 104, 106, 108 may be embodied as separate analog and digital circuits coupled to, but independent of, the controller 102. As pictured, each of the drivers 104, 106, 108 may be used to drive a corresponding print head 110, 112, 114. In some embodiments, one driver 104 may be used to drive all the print heads 110, 112, 114. The drivers 104, 106, 108 may be used to send data and clock signals to the corresponding print heads 110, 112, 114. In addition, the drivers 104, 106, 108 may be used to send firing pulse voltage signals to the corresponding print heads 110, 112, 114 to trigger individual nozzles of the print heads 110, 112, 114 to deposit specific quantities of ink or other fluid onto a substrate.

The drivers 104, 106, 108 may each be coupled directly to the power supply 118 so as to be able to generate a relatively high voltage firing pulse to trigger the nozzles to “jet” ink. In some embodiments, the power supply 118 may be a high voltage negative power supply adapted to generate signals having amplitudes of approximately 140 volts or more. Other voltages may be used. The drivers 104, 106, 108 may, under the control of the controller 102, send firing pulse voltage signals with specific amplitudes and durations so as to cause the nozzles of the print heads to dispense fluid drops of specific drop sizes as described, for example, in previously incorporated U.S. patent application Ser. No. 11/061,120, Attorney Docket No. 9769.

The print heads 110, 112, 114, may each include any number of nozzles 116, 118, 120. In some embodiments, each print head 110, 112, 114 may include one hundred twenty eight nozzles that may each be independently fired. An example of a commercially available print head suitable for used with the present invention is the model SX-128, 128-Channel Jetting Assembly manufactured by Spectra, Inc. of Lebanon, N.H. This particular jetting assembly includes two electrically independent piezoelectric slices, each with sixty-four addressable channels, which are combined to provide a total of 128 jets. The nozzles are arranged in a single line, at a 0.020″ distance between nozzles. The nozzles are designed to dispense drops from 10 to 12 picoliters but may be adapted to dispense from 10 to 30 picoliters. Other print heads may also be used.

Turning to FIG. 1B, a schematic illustration is provided depicting details of example connections within an embodiment of the controller of FIG. 1A. In a specific example embodiment, the controller 102 may drive, in parallel, three differently colored print head assemblies: Red 110′, Green 112′, and Blue 114′ (RGB). In some embodiments, each print head 110′, 112′, 114′ in the inkjet printing system 100 may be driven by a separate driver 104′, 106′, 108′. For example, each print head 110′, 112′, 114′ may be coupled to a driver 104′, 106′, 108′, respectively, of the controller 102. In some embodiments, particularly where the drivers 104′, 106′, 108′ are connected in parallel, a processor controlled communication hub 123 may be used to manage and optimize data downloads from the host 122 to the drivers 104′, 106′, 108′ so that the correct data is delivered to the correct driver 104′, 106′, 108′. Each print head/driver assembly may be assigned a unique media access control (MAC) and transmission control protocol/internet protocol (TCP/IP) addresses so that the processor controlled communication hub 123 may properly direct appropriate portions of the data. Thus, the host 122 and the drivers 104′, 106′, 108′ may each communicate directly via communications links, such as, for example, via Ethernet. In such embodiments, the controller 102 (or the system 100) may include an Ethernet switch-based communications hub 123, implemented using, for example, a model RCM3300 processor board manufactured by Rabbit Semiconductor of Davis, Calif. The drivers 104′, 106′, 108′ may thus include communications adapters such as Ethernet LAN devices. In some embodiments, the Ethernet LAN devices and other communications facilities may be implemented using, for example, an FPGA within the logic of the drivers 104′, 106′, 108′.

The drivers 104′, 106′, 108′ may be adapted to control the print heads based on a set of parameters, which may be transmitted to the drivers from the host 122 in the form of a command file. The host 122, which may, for example, be implemented using a VME workstation capable of real time processing, may transmit the commands and associated parameters directly to the respective drivers 104′, 106′, 108′ via, for example, individual RS232 serial and/or Ethernet communications paths. Thus, the drivers 104′, 106′, 108′ may include appropriate logic to connect to and communicate via Ethernet and/or RS232 serial lines.

Each driver 104′, 106′, 108′ may be coupled to each print head 110′, 112′, 114′ via, for example, a one-way 128 wire-path flat ribbon cable (represented by block arrows in FIG. 1B) so that each nozzle may receive a separate fire pulse. As mentioned above, power supply 124 may be coupled to each of the drivers 104′, 106′, 108′. The stage controller 126 may be coupled to each of the drivers 104′, 106′, 108′ via a one or two-way communications bus to provide substrate position or other information as mentioned above. For example, an RS485 communications path may be used. Thus, the drivers 104′, 106′, 108′ may include appropriate logic to connect to and communicate via an RS485 bus. Other communications facilities such as Ethernet and/or RS232 may also or alternatively be used. In various embodiments, the host 122 may include multiple two-way communications connections to the drivers 104′, 106′, 108′.

Turning to FIGS. 1C and 1F, a schematic illustration is provided depicting example details of a representative driver 104′ as shown in FIG. 1B. FIG. 1F is a schematic illustration of representative logic 132 included in the driver 104′ of FIG. 1C. Logic 132 includes a set of registers 160 for storing pattern parameter data (hereinafter ‘pattern data registers 160’), and is coupled to a look-up table memory 134. The pattern data registers 160 may be implemented by allocating storage areas in a FPGA device, and/or using independent flash or other memory components. Logic 132 is also coupled to a fire pulse generator circuit 138 and communications ports 140, 142, 144. In some embodiments, the driver 104′ may additionally include communications port 146 that is connected to communications port 144. The fire pulse generator 138 is connected to print head connector 146 which provides means to connect, for example, a ribbon cable to the corresponding print head 110′.

The logic 132 of driver 104′ (and each of drivers 106′, 108′) may be implemented using one or more FPGA devices that each include an internal processor, for example, the Spartan™-3E Series FPGAs manufactured by Xilinx®, Inc. of San Jose, Calif. In some embodiments, the logic 132 may include four identical 32-jet-control-logic segments (e.g., each of the four segments implemented on one of four Spartan™-3E Series FPGAs) to drive, for example, the 128 inkjet nozzles of a print head (e.g., the model SX-128, 128-Channel Jetting Assembly mentioned above).

In operation, the pattern data registers 160 may store data that the logic 132 uses to create logic level signals that are sent to the fire pulse generator 138 to trigger actual fire pulses that are sent to activate piezoelectric elements in the print head nozzles to dispense ink. In one embodiment, the pattern data registers 160 include separate registers for storing drop-to-drop spacing 161, drop size 162, a total number of pixels to print over the length of the substrate in the printing (Y) direction 163, the number of displays on the substrate in the Y direction 164, the distance (gap) between the displays 165, nozzle-to-nozzle delay information 166 related to the saber angle of the print heads relative to the print direction, and further spacing data which is used to indicate blank spaces in the pixel pattern and/or between pixels.

The look-up table memory 134 may store data from predetermined, correction lookup tables (e.g., determined during a calibration process) that may be used by the logic 132 to adjust the data sent to the fire pulse generator to trigger fire pulses. In some embodiments, 16 bits (e.g., a 16-bit resolution) may be used to define the fire pulse amplitude sent to each piezoelectric element in the print head assembly. The fire pulse amplitude may be used to indicate the amount of ink (e.g., drop size) to be deposited per jetting action. Using 16 bits to specify the fire pulse amplitude allows the controller 102 to have a 0.5 Pico-liter drop resolution. Thus, sixteen bits of fire pulse amplitude data may be stored for each nozzle or for each drop. Likewise, space in the look-up table memory 134 may be reserved for trigger voltage, pulse delay and/or pulse width adjustments on a per nozzle basis. Adjustments between print heads may also be stored in the look-up table memory 134. The logic 132 may also include further internal processor memory that may be used to interpret commands sent by the host 122, configure one or more gate arrays within the logic 132, and manage storage of data into the pattern data register 160 and look-up memory 134 which may be, e.g., flash memories. As indicated above, the driver 104′ generates the logic level pulses which encode the desired length and amplitude of the fire pulse. At the appropriate time (e.g., based on the position of the print head relative to a target pixel well), the logic level signals are individually sent to the fire pulse generator 138 which in response releases actual fire pulses to activate each of the inkjet nozzles of a print head.

The fire pulse generator 138, which generates the fire pulses for the piezoelectric elements of the print head, may, for example, be connected to the logic 132 and interfaced with the print head via a flat ribbon cable having an independent path for each logic level and fire pulse signal corresponding to each separate nozzle. These ribbon cables are represented in FIG. 1C by block arrows.

Turning to FIG. 1D, a partial schematic illustration is provided depicting example details of a fire pulse generator circuit of FIG. 1C for one inkjet nozzle. The fire pulse generator circuit 138 includes two input switches 150A, 150B that are coupled to and control current sources 152A, 152B, respectively. In some embodiments, the two input switches 150A, 150B may be the transistor-based and/or the current sources 152A, 152B may be implemented, for example, using switching mode field effect transistors (FETs). Current source 152A is coupled to a high voltage supply HV and current source 152B is coupled to ground 154. Both current sources 152A, 152B are also coupled to a line that leads to the piezoelectric element C_{pzt} (represented by a capacitor) of an individual inkjet nozzle. Note that although piezoelectric element C_{pzt} is shown as part of the fire pulse generator circuit 138 for illustrative purposes, the piezoelectric element C_{pzt} is actually out in the inkjet nozzles 116 (FIG. 1A) of a print head 110 (FIG. 1A).

Turning to FIG. 1E, a graph is provided depicting the voltage signal generated by a fire pulse generator circuit shown in FIG. 1D in response to input pulses from the logic 132 (FIG. 1C). In operation, a first logic level pulse received from logic 132 at input switch 150A causes input switch 150A to turn on current source 152A at T₁ which charges up piezoelectric element C_{pzt} (which electrically acts like a capacitor). Once the first logic level pulse ends at T₂, input switch 150A turns off current source 152A. When a second logic level pulse from logic 132 is received at input switch 150B at T₃, current source 152B is turned on and begins to discharge piezoelectric element C_{pzt}. Once the second logic level pulse ends at time T₄, input switch 150B turns off current source 152B.

As indicated above, the fire pulse generator circuit 138 uses a fixed-current source and transistors operated in a switching mode to control the charging and discharging events of a piezoelectric element C_{pzt}. As shown in FIG. 1E, the fixed-current source based circuit 138 generates a trapezoidal shaped fire pulse signal that varies linearly with time during charging and discharging, e.g., [V_{pzt}(t)=(Iₒ/C)t]. This constant slew rate feature is useful in controlling the drop size resolution, particularly during printing. For example, by varying the pulse width of the logic level signals from logic 132 (FIG. 1C), the amplitude of V_{pzt} can be precisely controlled which directly controls the ink drop size jetted by the piezoelectric element. More specifically, by moving the ending transition (logic high to low) of the logic level signal Pulse 1 to T₂′ (instead of T₂) and logic level signal Pulse 2 to T₄′ (instead of T₄), the amplitude of V_{pzt} is reduced and less ink is jetted. Likewise, by moving the ending transition of Pulse 1 to T₂″ (instead of T₂′) and logic level signal Pulse 2 to T₄″ (instead of T₄′), the amplitude of V_{pzt} is even further reduced and even less ink is jetted.

In contrast to the fixed current-based fire pulse generator circuit 138 that generates a constant slew rate fire pulse, a variable current RC-based circuit, in which the voltage varies exponentially with time, [V=V_{HV}(1−e^{-t/RC}), where V_{HV} is the raw DC supply voltage], has a variable slew rate and drop size resolution that is hard to control while the system 100 is printing.

FIG. 1G depicts a schematic perspective view of an exemplary inkjet print system 100. In some embodiments, the controller 102 and/or the print head drivers 104, 106, 108 may be housed in respective inkjet printing modules 115. In addition to the inkjet print heads 110, 112, 114, the printing modules 115 may be supported by carriages (not visible under/behind the inkjet printing modules 115) on the print bridge 117. Thus, the printing modules 115 may be adapted to move with (and remain proximate to) the print heads 110, 112, 114.

Overall System Operation

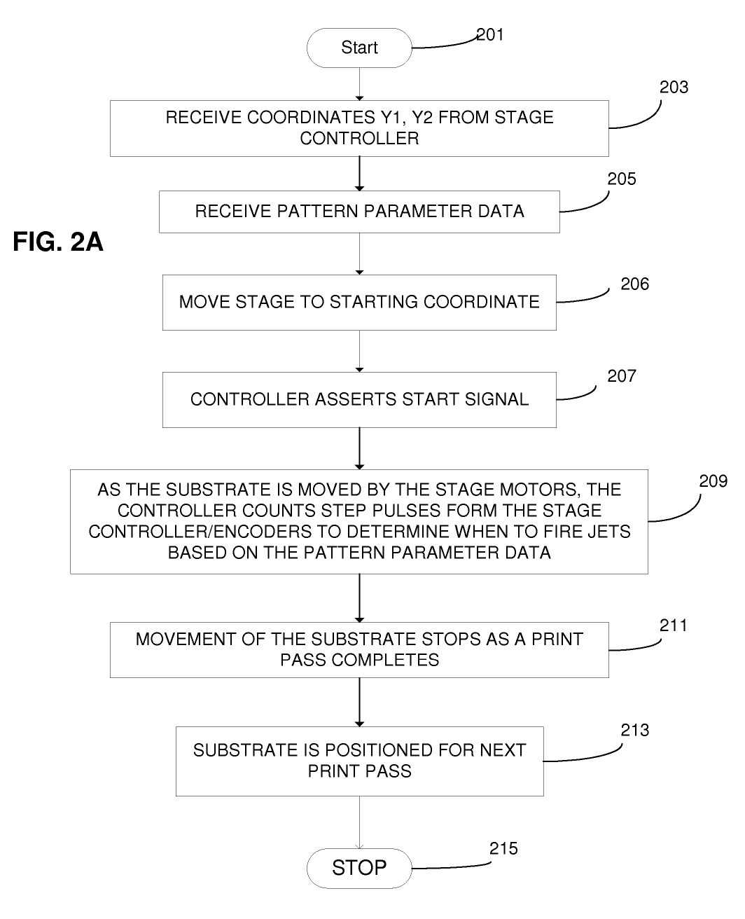

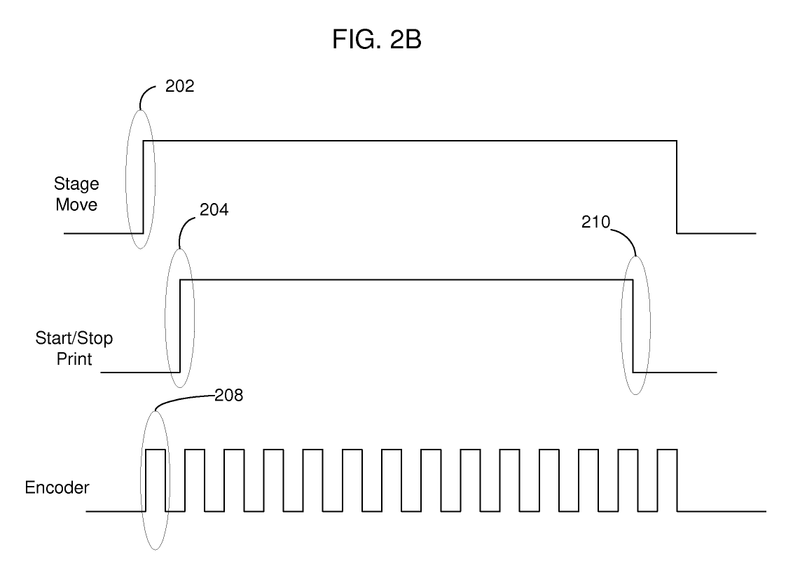

Referring to the flowchart of FIG. 2A, operation of the system begins at step 201. In operation, in step 203, the inkjet print system 100 receives starting and ending coordinates Y1, Y2 from the stage controller 126 which represent the beginning edge of the first pixel and the end of the last pixel on the substrate in the Y direction. In one example implementation, the stage controller 126 may obtain coordinates Y1, Y2 during a homing process in which certain fiducial marks imprinted on the substrate are detected using an optical detection apparatus. Offsets in X and Y dimensions with respect to a standard ‘home’ position of the substrate on the stage are determined based on the detected position of the fiducial marks. The starting and ending coordinates are then determined, in turn, from the offsets.

The commands including the pattern parameter data are then transferred from the host 122 to the controller 102 and thereby to the driver logic 132 of the respective print head drivers 104, 106, 108 in step 205. As an example, the pattern parameter data may represent a line of ink drops in a pixel well, each ink drop having a defined drop size and spacing with respect to neighboring drops.

Still referring to the flowchart of FIG. 2A, but also turning to the timing diagram 200 depicted in FIG. 2B, the host 122 may next issue a move command 202 to the stage controller 126 to cause the stage controller 126 to position the substrate S at the initial starting coordinate Y1 relative to the print heads 110, 112, 114 in step 206. Upon receiving an indication from the stage controller 126 that the stage is in position, in step 207, the stage controller 126 may then initiate a printing pass by asserting a start pulse 204 and step counter pulses 208 via an encoder. In step 209, the controller counts step counter pulses (n) as the stage moves the substrate a predetermined amount of distance per step counter pulse in a printing direction. In some embodiments, the controller 102 may track the counter pulses 208 (n) to determine a current position of the substrate. As the controller 102 receives the start pulse 204 and the step counter pulses 208, firing pulse voltage signals 210 may be sent by the controller 102 via the drivers 104, 106, 108 to individual nozzles that are arranged in a line (and may be approximately perpendicular to the printing pass direction, adjusted by a saber angle). The pattern parameter data in the controller 102 specifies whether a particular nozzle is to receive a firing pulse voltage signal that causes the nozzle to dispense fluid (i.e., “jet”) as it passes over a particular position (as indicated by the step counter pulses 208) in the printing direction. In step 211, when the end of a printing pass is reached, the stage controller 126 may assert a stop pulse 210. In step 213, a new move command (not shown) may be issued by the host 122 to position the substrate for a subsequent printing pass. Other timing relationships and/or signals may be used. Once all printing pass have completed, the method terminates in step 215.

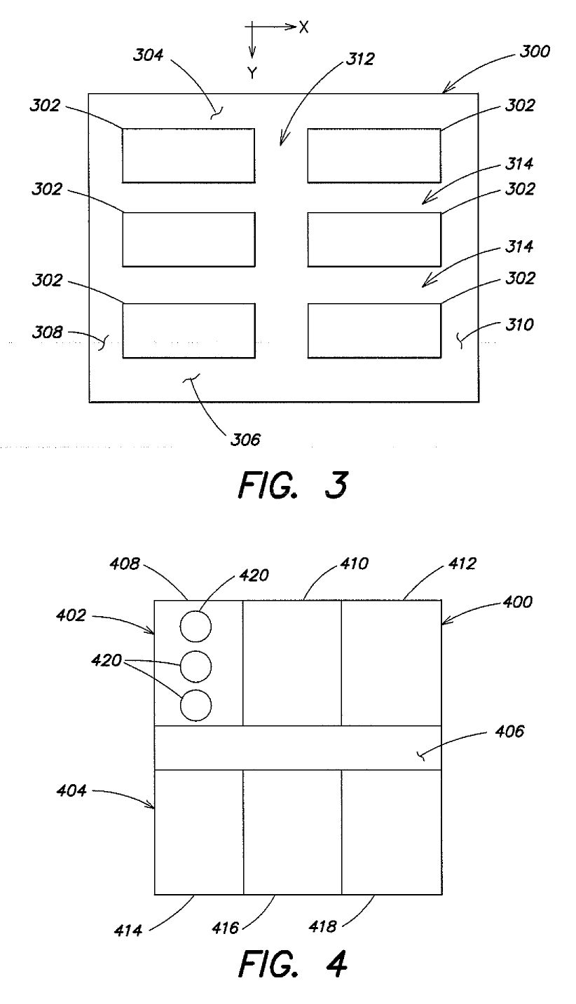

Turning to FIG. 3, a top view of an example substrate 300 is provided. The particular substrate 300 depicted in FIG. 3 is an example of a substrate 300 that may be suitable for use in manufacturing multiple display filters concurrently. With reference to FIG. 3, the substrate 300 includes six (6) individual display objects 302 that are shown as being contained on the substrate 300. However, any number of display objects 302 may be arranged on the substrate 300. As illustrated in FIG. 3, the substrate 300 may include a top margin 304, a bottom margin 306, a left side margin 308, and a right side margin 310. A gap 312 between display objects 302 in the X direction (e.g., perpendicular to the print direction moving horizontally across the substrate 300) is also shown. Gaps 314 between the display objects 302 in the Y direction (e.g., in the print direction moving vertically up or down the substrate 300) are also shown. Each display object 302 may include a number of display pixels (FIG. 4).

FIG. 4 is a magnified top view of an individual display pixel 400 of a display object 300 (FIG. 3), which, in an exemplary embodiment, includes two sub-pixels 402 and 404 separated by a capacitor line 406. In the particular example embodiment illustrated in FIG. 4, each sub-pixel 402, 404 includes three color filter regions 408, 410, 412; 414, 416, 418, respectively, each of the three being associated with a different color filter. Although FIG. 4 shows three (3) fluid drop positions 420 within a color filter region, any appropriate number of fluid drop positions can be specified. In an exemplary embodiment, as many as twenty (20) or more fluid drop positions can be specified and formed for a sub-pixel color filter region. A plurality of fluid drop positions 420 are shown in the left-most color region 408 of the top sub-pixel 402. Each of the fluid drop positions 320 are spaced a predetermined distance from the top edge of the top sub-pixel 402 and from each other so that the fluid drop locations 420 are equally spaced from each other and from the top and bottom edges of the sub-pixel 402. By placing the fluid drops at equal intervals, a more balanced and consistent color filter may be obtained.

However, other drop positions may be used. In cases in which the two sub-pixels 402, 404 are to have different volumes, the fluid drop volume can be adjusted differently between the two sub-pixels 402, 404 so that the filled thicknesses remain approximately the same despite a difference in area.

As indicated above, pattern parameter data that may be stored in driver logic are used to control fluid drop positioning on a substrate. The pattern parameter data may include drop spacing, drop size, the number of drops per pixel (m), pixel boundary spacing, the number of pixels per display object (p), the number of display objects per substrate (q), display boundary spacing, and nozzle-to-nozzle delay information. Corrective displacement information may also be used to adjust drop position for individual nozzle misalignment, substrate surface imperfections, etc. For example, if during a calibration process, it is determined that a particular nozzle is misaligned such that the nozzle consistently deposits ink 0.5 micrometers behind (in the print direction) where expected, corrective displacement information may be used to shift the drop location (e.g., via changing the fire pulse timing) of all drops to be jetted by the misaligned nozzle.

Based on this information, the controller 102 (and/or host 122), in an exemplary embodiment, may determine the actual physical position for each fluid drop to be deposited in a respective sub-pixel color filter region. The controller 102 (and/or host 122) may be programmed to automatically determine the respective actual fluid drop timing so as to evenly distribute the fluid drops inside a sub-pixel's color filter region.

In some cases, the position of a fluid drop may be shifted from its desired location due to errors in motion of the stage 129 (FIG. 1) (e.g., due to motion accuracy or resolution) or offset errors between display objects. In extreme cases, a drop may land outside a target pixel region and become a defect. In some embodiments, to avoid such errors, dynamic adjustment of inkjet head position during inkjetting may be employed. For example, a camera or other detector (e.g., such as a visualization device, an inspection device, and/or another similar device) may be employed to check inkjet head and/or nozzle position relative to a substrate pixel prior to inkjetting. Inkjet head and/or nozzle position information may be fed to the controller 102 (or other controller), and an offset may be determined to correct any positioning error, for example, for each display object.

In at least one embodiment, inkjet head position and/or nozzle firing/jetting time may be adjusted while printing (e.g., while the stage 129 is in motion) based on the determined offset. For example, assuming that the stage 129 travels along a y-axis direction (e.g., at a constant rate) during inkjetting, an error in the y-axis position of an inkjet head may be compensated for by jetting from a nozzle of the inkjet early, late or not at all. Likewise, an error in an x-axis direction position (e.g., perpendicular to the stage's direction of travel) may be compensated for by adjusting the x-axis position of the inkjet head prior to printing (e.g., by moving the inkjet head to the left or right relative to the direction of travel so that a nozzle is properly positioned over a pixel location). Such an “on-the-fly,” self-compensation mechanism may greatly improve printing accuracy by compensating for dynamic errors in inkjet head position. In general, the in-line position, lateral position, height, pitch, yaw, etc., of a print head may be dynamically adjusted (e.g., while the stage remains in motion).

Exemplary Method for Pattern Data Use

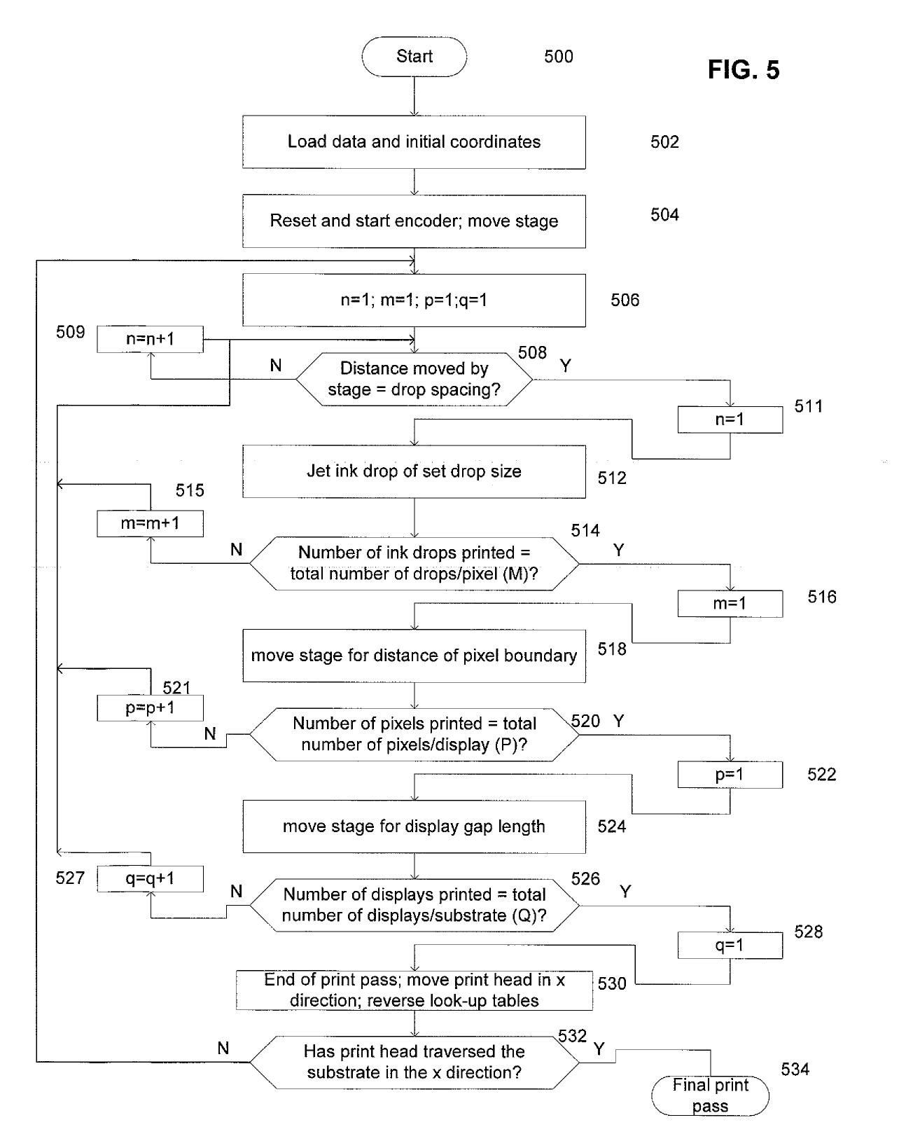

FIG. 5 is a flowchart of an exemplary algorithm for printing ink drops based on pattern data according to some embodiments of the present invention. The printing may occur on a substrate having any number of display objects or a substrate having only a single display object.

With reference to FIG. 5, the operation of the controller 102 commences at Step 500. At step 502, pattern parameter data for a substrate 300 may be entered into or loaded into the controller 102 together with the initial printing margin coordinates Y1, Y2. In another exemplary embodiment, the pattern parameter data may be retrieved from a memory device (not shown) located internal to the controller 102 or located in a memory device external from the controller 102. The pattern parameter data can be input or loaded into the controller 102 from any appropriate storage medium such as, but not limited to a floppy disk, a compact disk (CD), a digital versatile disk (DVD), or any other suitable storage medium. In another exemplary embodiment, the pattern parameter data can be transferred, downloaded, or uploaded, from another computer (e.g., a host 122) or database which can be adapted to store such data.

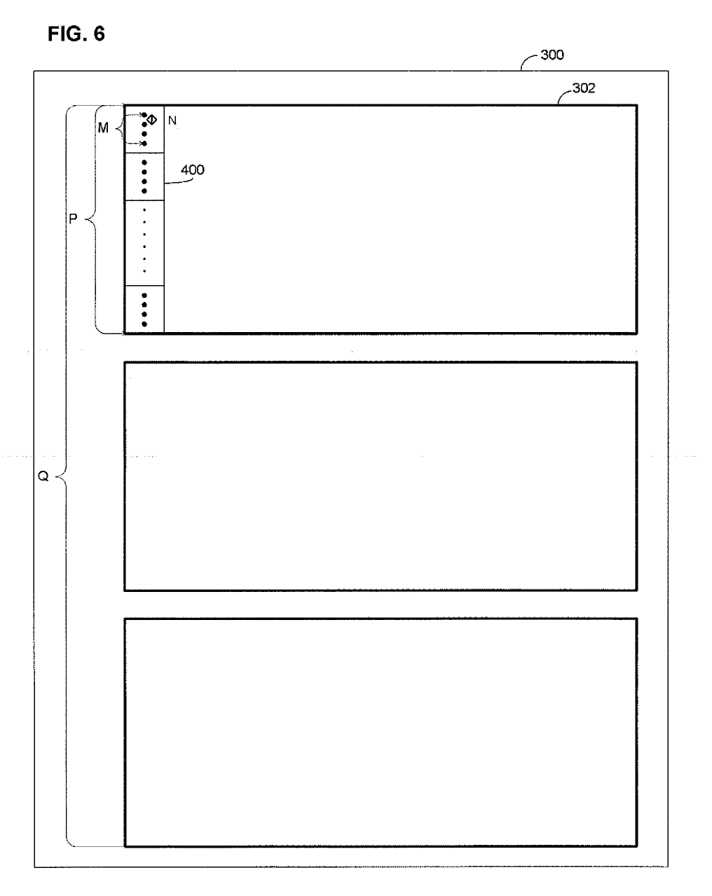

The pattern parameter data may include any of the data and/or information described above as well as data and/or information regarding the substrate, a display object or objects, display pixels, sub-pixels, the length in the x-direction of the substrate 300 and/or the display objects 302, the length in the y-direction of the substrate 300 and/or the display objects 302, any gap or gaps in the Y-direction 314, the number of display objects in the X-direction, the number of display objects in the Y-direction, and/or any other and/or any other information, described herein and/or otherwise useful for concisely representing a printing pattern. FIG. 6 is a top view of a substrate illustrating the following parameters that may be included in pattern parameter data: drop spacing (N), drops per pixel (N), pixels per display (P) and displays per substrate (Q). It is noted that these parameters may alternatively be calculated using the driver logic 132 from other related parameters that are provided. For instance, the number of pixels per display may be calculated from known pixels per substrate and displays per substrate by division.

At step 504, a stage movement encoder is reset to zero and started as the stage 129 is moved in the Y-direction. At step 506, the controller creates temporary counter variables n, m, p, q and initializes each at one (1). The variables n, m, p and q respectively represent a number of recorded encoder pulses (n), a number of ink drops jetted (m), a number of pixels printed (p), and a number of displays printed (q). As the stage is moved and ink drops are jetted, each of these counters is updated to reflect how much of the current print pass has been completed.

After initialization, the controller directs the stage 129 to move in the Y-direction. In an exemplary embodiment, the stage 129 can move at a speed of approximately 500 mm/sec and a nozzle of a respective print head may be operated to jet approximately every 25 μsec (hereinafter “the jetting frequency”). Thus, the in this example, a nozzle of a print head may fire (minimally) approximately once every 12.5 μm. A counter n may be set to increment by 1 each time the Y-direction stage encoder 130 sends a pulse indicating that the stage has traveled the minimal firing distance 12.5 μm. It is noted that the minimal firing distance at which the counter increments will of course vary depending on the stage speed and nozzle firing characteristics, and that the specific distance of 12.5 μm is merely exemplary.

At step 508, it is determined whether the counter (n) indicates that the distance traveled by the stage 129 has reached the drop spacing distance (N). If it has not, the stage is moved, the counter (n) is incremented (at step 509), and then the process cycles back to the determination step 508. If the counter (n) has reached N, indicating that the stage 129 has moved by the drop spacing distance, the counter (n) is reset to one (1) at step 511, and at step 512, the controller 102 triggers a firing pulse of appropriate voltage and amplitude to jet a drop of ink of a size indicated in the pattern parameter data, while incorporating any adjustment information provided in the look-up tables 134.

At step 514, it is determined whether the counter (m) has reached the set number of drops per pixel (M), indicating that the current pixel has been completely printed. If it has not, this indicates that further drops are required to complete the pixel; the counter m is incremented by one at step 515 to indicate that another drop has been printed, and the process cycles back to step 508 for further inkjetting. If the counter (m) has reached M, the counter m is reset to one (1) at step 516, and then the stage is moved for a prescribed distance at step 518 to delineate a space before the next pixel is printed.

At step 520, it is determined whether the counter (p) has reached the set number of pixels per display (P), indicating that the current display has been completely printed. If it has not, this indicates that further pixels are required to complete the display; the counter p is incremented by one at step 521 to indicate that another pixel has been completed, and the process cycles back to step 508 for further inkjetting. If the counter (p) has reached P, the counter p is reset to one (1) at step 522, and then the stage is moved for a prescribed distance at step 524 to delineate a gap between displays.

At the next resolution level, at step 526, it is determined whether the counter (q) has reached the set number of displays per substrate (Q), indicating that all of the displays on the substrate have been covered in the current print pass. If it has not, this indicates that further displays are required to complete the print pass; the counter q is incremented by one at step 527 to indicate that another display has been covered by the current print pass, and the process cycles back to step 508 for further inkjetting. If the counter (q) has reached Q, the counter q is reset to one (1) at step 528.

At step 530, the end of the current print pass has been reached; the controller 102 moves the print head in the X-direction and reverses the data in the look tables 134 for initializing the next print pass.

Additional print passes are performed similarly until the final print pass is reached, which may be determined when the stage 129 provides X-position information to the controller indicating that the print heads 110, 112, 114 have traversed the substrate in the X-direction (step 532). At this point, there may be enough space left on the substrate to accommodate a partial print pass but not a full print pass (step 534). The pattern parameter data may include ‘mask’ information for this case and/or it may be calculated using the driver logic from the known parameters. The controller 102 can use the mask information to direct one or more of the print heads 110, 112, 114 not to print in one or more locations. In this manner, the pattern parameter information provides for partial printing during the final print pass.

The foregoing description discloses only particular embodiments of the invention; modifications of the above disclosed methods and apparatus which fall within the scope of the invention will be readily apparent to those of ordinary skill in the art. For example, the present invention may also be applied to spacer formation, polarizer coating, and nanoparticle circuit forming.

Accordingly, while the present invention has been disclosed in connection with specific embodiments thereof, it should be understood that other embodiments may fall within the spirit and scope of the invention, as defined by the following claims.

The invention claimed is:

1. A system for manufacturing display objects comprising:
a print controller including at least one driver;
at least one print head coupled to the at least one driver;
a stage controller coupled to the print controller;
at least one motor coupled to the stage controller;
at least one encoder coupled to the at least one motor and the stage controller; and
a host coupled to the stage controller and the print controller,
wherein the host is adapted to transfer pattern parameter data to the print controller, and the print controller is adapted to use the pattern parameter data to trigger the at least one print head to deposit ink into pixel wells on a substrate as the substrate is moved in a print direction by the at least one motor under the direction of the stage controller in response to a command from the host.

2. The system of claim 1 further comprising a real time controller coupled to the controller and the at least one encoder and adapted to provide an enable signal to the print controller when the substrate is in position for printing.

3. The system of claim 1 wherein the at least one driver includes logic coupled to a memory and a fire pulse generator circuit.

4. The system of claim 3 wherein the logic is further coupled to the host and the stage controller.

5. The system of claim 3 wherein the logic includes one or more registers adapted to store the pattern parameter data.

6. The system of claim 5, wherein the logic is adapted to:
a) determine a timing for firing the fire pulse generator circuit based on the starting coordinate, motion of the substrate under the direction of the stage controller, and drop spacing information provided in the pattern parameter data; and
b) to transmit logic level signals to the fire pulse generator based on the timing for firing.

7. The system of claim 5 wherein the logic is adapted to store corrective displacement data in the memory and to modify the logic level signals based on the corrective displacement data.

8. The system of claim 5 wherein the pattern parameter data includes drop size information and the logic level signals further indicate an amount of ink to be jetted.

9. The system of claim 8 wherein the fire pulse generator circuit operates based on a fixed current source circuit and the amount of ink to be jetted is varied by the logic.

10. An apparatus for controlling an inkjet printing system comprising:
logic including a processor;
memory coupled to the logic; and
a fire pulse generator circuit coupled to the logic and including a connector to facilitate coupling to a print head,
wherein the logic is adapted to receive pattern parameter data, and the logic is further adapted to trigger the print head to deposit ink into pixel wells on a substrate as the substrate is moved in a print direction based on the pattern parameter data.

11. The apparatus of claim 10 wherein the logic is further coupled to communication ports adapted to connect to a host and a stage controller.

12. The apparatus of claim 11 wherein the logic includes on ore more registers adapted to store the pattern parameter data.

13. The apparatus of claim 12, wherein the logic is adapted to:
a) determine a timing for firing the fire pulse generator circuit based on the starting coordinate, motion of the substrate under the direction of the stage controller, and drop spacing information provided in the pattern parameter data; and
b) transmit logic level signals to the fire pulse generator based on the timing for firing.

14. The apparatus of claim 13 wherein the logic is adapted to store corrective displacement data in the memory and to modify the logic level signals based on the corrective displacement data.

15. The apparatus of claim 13 wherein the pattern parameter data includes drop size information and the logic level signals further indicate an amount of ink to be jetted.

16. The apparatus of claim 15 wherein the fire pulse generator circuit operates based on a fixed current source circuit and the amount of ink to be jetted is varied by the logic.

17. A method of manufacturing an inkjet printing system comprising:
providing logic including a processor;
coupling memory to the logic;
coupling a fire pulse generator circuit to the logic;
coupling a connector to the fire pulse generator to facilitate coupling to a print head; and
adapting the logic to receive pattern parameter data to be used to trigger the print head to deposit ink into pixel wells on a substrate as the substrate is moved in a print direction.

18. The method of claim 15 further comprising coupling the logic to communication ports adapted to connect to a host and a stage controller.

19. The method of claim 18 further comprising storing the pattern parameter information in registers included in the logic.

20. The method of claim 19, further comprising adapting the logic to:
a) determine a timing for firing the fire pulse generator circuit based on the starting coordinate, motion of the substrate under the direction of the stage controller, and drop spacing information provided in the pattern parameter data; and
b) to transmit logic level signals to the fire pulse generator based on the timing for firing.

21. The method of claim 20 further comprising adapting the logic to store corrective displacement data in the memory and to modify the logic level signals based on the corrective displacement data.

22. The method of claim 20 wherein the pattern parameter data includes drop size information.

23. The method of claim 22 further comprising adapting the fire pulse generator circuit to use a fixed current source circuit and adapting the logic to vary the amount of ink to be jetted based on the drop size information.

24. A method of printing color filters comprising:
receiving pattern parameter data;
controlling a fixed current source fire pulse generator circuit based on the pattern parameter data; and
activating a print head using a fire pulse generated by the fixed current source fire pulse generator circuit.

25. The method of claim 24 wherein the pattern parameter data includes drop size information and wherein controlling a fixed current source fire pulse generator circuit includes sending logic level signals to the fixed current source fire pulse generator circuit that indicate an amount of ink to be jetted.

26. The method of claim 25 wherein sending logic level signals to the fixed current source fire pulse generator circuit includes sending logic level signals that cause an amplitude of the fire pulse to vary linearly with time.

27. The method of claim 25 wherein controlling a fixed current source fire pulse generator circuit includes sending logic level signals to the fixed current source fire pulse generator circuit that indicate when the print head is to jet ink.

28. The method of claim 24 wherein activating a print head includes using a fire pulse having a constant slew rate.
